(19) United States
(12) Patent Application Publication
(10) Pub. No.: US 2026/0361890 A1
(43) Pub. Date: Nov. 12, 2026

(54) VIDEO CODING METHOD AND APPARATUS, DEVICE, AND STORAGE MEDIUM

(71) Applicant: DOUYIN VISION CO., LTD., Beijing (CN)

(72) Inventors: Hongen Jie, Beijing (CN); Jicheng Wang, Beijing (CN); Wenyao Gan, Beijing (CN)

(21) Appl. No.: 19/129,639

(22) PCT Filed: Mar. 18, 2024
(86) PCT No.: PCT/CN2024/082269

§ 371 Date: May 13, 2025

(30) Foreign Application Priority Data
Apr. 26, 2023 (CN) 202310465726.1

(51) Int. Cl. H04N 19/142; H04N 19/172; H04N 19/177; H04N 19/87

(52) U.S. Cl. CPC H04N 19/142; H04N 19/172; H04N 19/177; H04N 19/87

(57) ABSTRACT

Provided in embodiments of the disclosure are a method and apparatus for encoding a video, a device, and a storage medium. The method includes: obtaining a target video to be encoded; determining a switching video frame in the target video based on video frame information of each video frame in the target video, where the switching video frame is used to represent a video switching position in response to switching a playback mode; and performing multi-mode encoding on the target video with the switching video frame as a key frame, so as to obtain an encoded video corresponding to each playback mode.

### CROSS-REFERENCE TO RELATED APPLICATION(S)

The disclosure is a national stage application filed under 35 U.S.C. 371 based on International Patent Application No. PCT/2024/082269, filed Mar. 18, 2024, which claims the priority to Chinese Patent Application No. 202310465726.1, filed on Apr. 26, 2023, and entitled “Video Coding Method and Apparatus, Device, and Storage Medium”, which are incorporated herein by reference in their entireties.

### FIELD

Embodiments of the disclosure relate to the computer technology, and in particular to a method, an apparatus, a device, and a storage medium for encoding a video.

### BACKGROUND

With rapid development of the computer technology, it is feasible to encode and play back the same video in multiple modes. At present, it is common to encode the same video independently through an encoder corresponding to each playback mode.

### SUMMARY

The disclosure provides a method and apparatus, a device, and a storage medium for encoding a video. Thus, alignment of a video picture can be ensured in response to switching a playback mode, and continuity of video switching can be improved.

In a first aspect, a method for encoding a video is provided in embodiments of the disclosure. The method includes:
acquiring a target video to be encoded;
determining a switching video frame in the target video based on video frame information of each video frame in the target video, where the switching video frame is used to represent a video switching position in response to switching a playback mode; and performing multi-mode encoding on the target video with the switching video frame as a key frame to obtain an encoded video corresponding to each playback mode.

In a second aspect, an apparatus for encoding a video is provided in the embodiments of the disclosure. The apparatus includes:
a target video acquisition module configured to acquire a target video to be encoded;
a switching video frame determination module configured to determine a switching video frame in the target video based on video frame information of each video frame in the target video, and the switching video frame is used to represent a video switching position in response to switching a playback mode; and
a multi-mode encoding module configured to perform multi-mode encoding on the target video with the switching video frame as a key frame to obtain an encoded video corresponding to each playback mode.

In a third aspect, an electronic device is further provided in the embodiments of the disclosure. The electronic device includes:
one or more processors; and
a storage apparatus configured to store one or more programs;
the one or more programs cause the one or more processors to perform any method for encoding a video according to the embodiments of the disclosure when executed by the one or more processors.

In a fourth aspect, a storage medium comprising computer-executable instructions are further provided in the embodiments of the disclosure. The computer-executable instruction causes a computer processor to perform any method for encoding a video in the embodiments of the disclosure.

### BRIEF DESCRIPTION OF THE DRAWINGS

The above and other features, advantages, and aspects in each example of the disclosure will become more apparent with reference to the accompanying drawings and the following particular embodiments. The same or similar reference numerals denote the same or similar elements throughout the accompanying drawings. It should be understood that the accompanying drawings are illustrative, and original devices and elements are not necessarily drawn to scale.

FIG. 1 is a schematic flowchart of a method for encoding a video according to an embodiment of the disclosure;

FIG. 2 is a schematic flowchart of another method for encoding a video according to an embodiment of the disclosure;

FIG. 3 is a schematic flowchart of yet another method for encoding a video according to an embodiment of the disclosure;

FIG. 4 shows an example of a frame serial number corresponding to a video frame involved in an embodiment of the disclosure;

FIG. 5 is a schematic structural diagram of an apparatus for encoding a video according to an embodiment of the disclosure; and

FIG. 6 is a schematic structural diagram of an electronic device according to an embodiment of the disclosure.

### DETAILED DESCRIPTION OF EMBODIMENTS

Embodiments of the disclosure will be further described in detail below in conjunction with the accompanying drawings. Although some embodiments of the disclosure are shown in the accompanying drawings, it should be understood that the disclosure can be implemented in various forms and should not be interpreted as being limited to the embodiments set forth herein. On the contrary, these embodiments are provided for more thorough and complete understanding of the disclosure. It should be understood that the accompanying drawings and the embodiments of the disclosure are merely illustrative, and are not intended to limit the scope of protection of the disclosure.

It should be understood that various steps described in a method embodiment of the disclosure can be executed in different orders and/or in parallel. In addition, the method embodiment can include additional steps and/or will not execute the steps shown. The scope of the disclosure is not limited in this respect.

The terms “comprise”, “include”, and their variations used herein represent open-ended inclusions, i.e. “comprise, but is not limited to” and “include, but is not limited to”. The term “based on” means “at least partially based on”. The term “an example” represents “at least one example”. The term “another example” represents “at least one further example”. The term “some embodiments” represents “at least some embodiments”. The definitions relevant to other terms are set forth in the description below.

It should be noted that the concepts “first”, “second”, etc. mentioned in the disclosure are merely used to distinguish between different apparatuses, modules, or units, instead of defining an order or interdependence relation of functions executed by these apparatuses, modules, or units.

It should be noted that the modifiers “a”, “an”, and “a plurality of” mentioned in the disclosure are illustrative rather than restrictive. Those skilled in the art should understand that these modifiers should be interpreted as “one or more” unless clearly indicated otherwise in the context.

The name of a message or information interacting between a plurality of apparatuses in the embodiments of the disclosure is merely descriptive, and is not intended to limit the scope of the message or information.

It can be understood that before the technical solutions disclosed in the embodiments of the disclosure are used, a user should be notified of a type, use scope, use scenario, etc. of personal information involved in the disclosure in an appropriate manner according to relevant laws and regulations, and authorization from the user should be acquired.

It can be understood that the data (including, but not limited to, the data itself and acquisition or use of the data) involved in the technical solution should comply with the requirements in corresponding laws and regulations and relevant provisions.

However, misalignment of video pictures will be caused when the playback mode is switched, and thus continuity of video switching is lowered because of independence of the encoded video corresponding to each playback mode and obtained through such an encoding method.

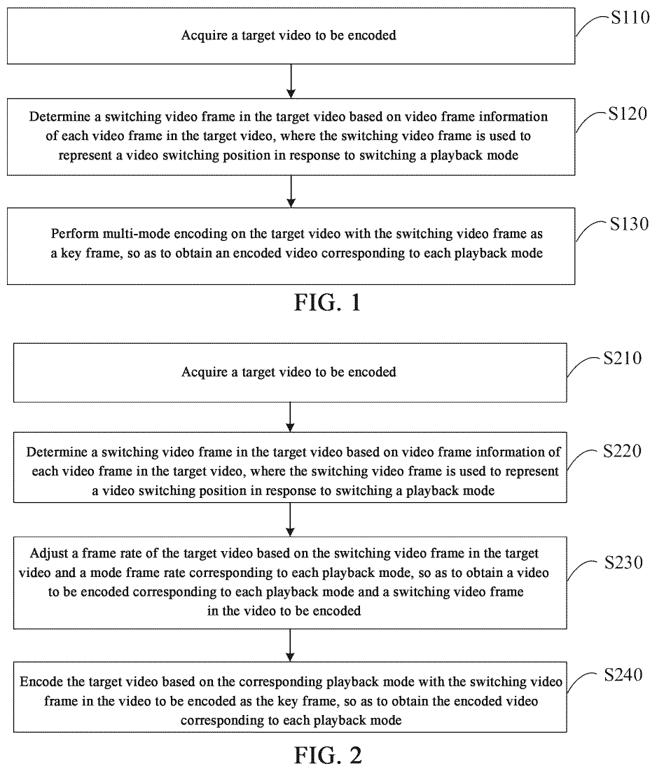

FIG. 1 is a schematic flowchart of a method for encoding a video according to an embodiment of the disclosure. The example of the disclosure is applicable to the case of performing multi-mode encoding on a same video, and particularly applicable to an application scenario of performing multi-mode encoding on a video in a video transcoding process. The method can be executed by an apparatus for encoding a video. The apparatus may be implemented in a form of software and/or hardware. Optionally, the apparatus can be implemented by an electronic device. The electronic device can be a server, a personal computer (PC), etc.

As shown in FIG. 1, the method for encoding a video may specifically include:

S110, a target video to be encoded is acquired.

The target video may represent any video requiring multi-mode encoding. For example, the target video may represent a live video, an on-demand video, an original video uploaded by a user, etc.

Specifically, a user terminal may encode a video to be uploaded in response to a video upload operation triggered by the user, and upload an encoded video to a server. The server performs multi-channel transcoding on the video uploaded by the user terminal. In a multi-channel transcoding process, the video uploaded by the user terminal is decoded first to obtain an original video. Then, multi-code encoding is performed on the original video serving as the target video. An encoded video obtained may be decoded and played back by a player.

S120, a switching video frame in the target video is determined based on video frame information of each video frame in the target video, and the switching video frame is used to represent a video switching position in response to switching a playback mode.

The target video may consist of multiple video frames. The video frame information of each video frame represents picture information that can reflect importance of the video frame. For example, the video frame information may include at least one of texture information, motion information, shot switching information, shot scene information, a playback timestamp. The shot scene information may be used to represent different range information presented by a shooting subject in a shot due to different distances between the shot and the shooting subject when a focal length is constant. For example, a shot scene may be divided into five categories from near to far, i.e. a close-up, a close shot, a medium shot, a full shot, and a long shot. The more complex the texture, the smaller the motion, the more obvious the shot switching, the closer the shot scene or the earlier the playback timestamp, and the higher the importance of the video frame, i.e., the higher the value of the video frame. The switching video frame may be a switching point for switching the playback mode in the target video. For example, the switching video frame may represent an important video frame in the target video, i.e. a high-value video frame. The playback mode may represent a video mode selectable when the video is played back. There are multiple playback modes. Different playback modes have a same video playback content with different video playback effects. Different playback modes may be divided based on any picture parameter. For example, when the modes are divided by resolution of the video frame, each resolution mode is equivalent to one playback mode. For example, the resolution mode may include a high-resolution mode (for example, at 720p), a medium-resolution mode (for example, at 540p), and a low-resolution mode (for example, at 360p). Multiple switching video frames exist in the target video, so that the playback mode of the target video may be switched at multiple positions.

Specifically, as an implementation, based on the playback timestamp of each video frame in the target video, video frames spaced apart by preset playback duration may be directly taken as the switching video frames, or video frames at each preset playback timestamp may be taken as the switching video frames. For example, when the target video is a short video, more preset play timestamps may be set at the beginning of the video to determine more switching video frames at the beginning, which is conducive to starting of video playback. Fewer preset play timestamps may be set at the end of the video to determine fewer switching video frames at the end, which is conducive to subsequent encoding and compression.

As another implementation, each video frame in the target video may be intelligently analyzed to obtain the video frame information of each video frame, and a video frame with higher importance in the target video may be determined as the switching video frame through comparison of each piece of the video frame information. Thus, a video frame with a high value may be subsequently encoded as the key frame, so that encoding performance can be improved. For example, weighted summation may be performed on the texture information, the motion information, the shot switching information, the shot scene information, and the playback timestamp corresponding to each video frame to obtain the importance corresponding to each video frame. The video frame with an importance greater than a preset threshold is taken as the switching video frame to obtain all switching video frames with the high values in the target video. The more complex the texture corresponding to the video frame, the higher the importance of the video frame. The more complex the texture corresponding to the video frame, the higher the importance of the video frame. The more obvious the shot switching corresponding to the video frame, the higher the importance of the video frame. On the premise of high definition and low code, the smaller the shot motion of the video frame, the higher the importance of the video frame, the closer the shot scene of the video frame, and the higher the importance of the video frame. The earlier the playback timestamp of the video frame, the higher the importance of the video frame.

Illustratively, S120 may include: the video frame information of each video frame in the target video is input into a target network model obtained by pre-training to predict the switching video frame; and the switching video frame in the target video is determined based on a prediction result output by the target network model.

The target network model may be a neural network model configured to predict whether one video frame is the switching video frame. For example, the target network model may be a binary classification network architecture. The target network model is obtained by pre-training the model based on sample data and sample tags to ensure prediction accuracy of the target network model.

Specifically, at least one of the video frame information (such as the texture information, the motion information, the shot switching information, the shot scene information, and the playback timestamp) of each video frame in the target video may be input into the target network model obtained by pre-training. The target network model may predict whether the corresponding video frame is the switching video frame based on the video frame information input, and may output a predicted probability that the corresponding video frame is predicted to be the switching video frame. Thus, a predicted probability that each video frame is the switching video frame is obtained. Video frames with a predicted probability greater than a preset probability threshold are taken as the switching video frames, so that all the switching video frames in the target video can be determined more rapidly and accurately through the target network model.

S130, multi-mode encoding is performed on the target video with the switching video frame as a key frame, so as to obtain an encoded video corresponding to each playback mode.

The key frame may represent a video frame that can retain complete information during encoding. The encoded video represents the video obtained by encoding the target video based on each mode. When encoded, the video frames may be encoded as the key frames (i.e. I frame), forward predictively-encoded frame (i.e. P frames), or bidirectional predictively-encoded frames (i.e. B frames). The I frames are decoded only through information of the key frames, without reference to other video frames. A big interval is provided between two I frames. The P frames are decoded only if reference is made to information of video frames before current frames. The phenomenon of a blurred screen will be caused if the reference video frames are dropped. The B frames are decoded only if reference is made to video frames before and after current frames. The phenomenon of a blurred screen will be caused if the reference video frames are dropped.

Specifically, each playback mode corresponds to an encoder, and the target video is input to each encoder. Each encoder encodes the target video based on the corresponding mode with the switching video frame in the target video as the key frame to obtain the encoded video corresponding to each playback mode. Different encoders perform encoding with a same switching video frame as the key frame, so that alignment of the key frame in the encoded video corresponding to each playback mode can be implemented. By determining a position of the key frame outside the encoder, alignment of the key frame can be effectively ensured. The encoding performance can also be effectively ensured by performing encoding with the high-value switching video frame in the target video as the key frame. Through alignment of the switching video frame in the encoded video corresponding to each playback mode, switching video pictures can be ensured to be a same picture in response to switching the playback mode, so that continuity of the video playback pictures in response to switching the playback mode is improved.

According to the technical solution in the example of the disclosure, the switching video frame in the target video is determined based on the video frame information of each video frame in the target video to be encoded, and the switching video frame is used to represent the video switching position in response to switching the playback mode. Encoding is performed with the switching video frame in the target video as the key frame in each mode. Thus, the switching video frame in the encoded video corresponding to each playback mode is aligned, so that alignment of the switching video picture can be ensured in response to switching the playback mode, and continuity of video switching can be improved.

On the basis of the above technical solution, after S130, the method further includes: a first encoded video corresponding to a first playback mode is played back, and a second playback mode to be switched to is determined in response to a playback mode switching instruction; and switch to the second playback mode is performed in response to reaching a switching position corresponding to a switching video frame in the first encoded video, and a second encoded video corresponding to the second playback mode is synchronously played back.

The first playback mode may represent a default playback mode or a playback mode selected by the user for the first time. The playback mode switching instruction may be an instruction to switch from the first playback mode to the second playback mode. The playback mode switching instruction may be generated based on a playback mode switching operation triggered by the user autonomously. For example, the playback mode switching instruction is generated based on the second playback mode selected by the user, so that the mode is switched manually. Alternatively, the playback mode switching instruction may be automatically generated based on a network change condition. For example, when it is detected that a network speed is getting slow, the second playback mode matching a current network speed is determined, and the playback mode switching instruction is generated based on the second playback mode, so that the mode is switched automatically.

Specifically, the server may pre-deliver the encoded video corresponding to each playback mode to the user terminal, or deliver the encoded video corresponding to each playback mode to the user terminal in real time. The player in the user terminal may play back the first encoded video corresponding to the first playback mode. It should be noted that the player needs to decode each encoded video before playback. In a process of playing the first encoded video by the player, the player may determine to switch from the first playback mode to the second playback mode in response to the playback mode switching instruction, and perform mode switching and synchronous playback in response to playback to the switching position corresponding to the switching video frame in the first encoded video. Thus, continuity of video playback after the mode is switched can be ensured.

For example, each encoded video consists of multiple groups of pictures (GOPs). If a first picture frame in each group of pictures is the key frame corresponding to the switching video frame, the playback mode may be switched by switching the group of pictures. For example, the player may perform switch to the second playback mode and play back a next group of pictures in the second encoded video synchronously in response to playback to a last video frame in a current group of pictures in the first encoded video, i.e. completion of playback of the current group of pictures in first encoded video. A first video frame in a next group of pictures in the first encoded video and a first video frame in the next group of pictures in the second encoded video are a same switching video frame, so that picture continuity in response to switching the mode is ensured.

For another example, the switching position corresponding to the switching video frame in each encoded video may alternatively be marked. After the playback mode is switched, the player continues playing the first encoded video to a marked position in the first encoded video, and performs the switch to the second playback mode to synchronously play back video frames after the marked position in the second encoded video corresponding to the second playback mode. Thus, picture continuity in response to switching the mode can also be ensured.

FIG. 2 is a schematic flowchart of another method for encoding a video according to an example of the disclosure. On the basis of the example disclosed above, in the example of the disclosure, the step that “multi-mode encoding is performed on the target video with the switching video frame as a key frame to obtain an encoded video corresponding to each playback mode” is optimized. The explanations of terms identical or corresponding to those in each example disclosed above will not be repeated herein.

As shown in FIG. 2, the method for encoding a video may specifically include:

S210, a target video to be encoded is acquired.

S220, a switching video frame in the target video is determined based on video frame information of each video frame in the target video, where the switching video frame is used to represent a video switching position in response to switching a playback mode.

S230, a frame rate of the target video is adjusted based on the switching video frame in the target video and a mode frame rate corresponding to each playback mode to obtain a video to be encoded corresponding to each playback mode and a switching video frame in the video to be encoded.

The mode frame rate may represent a video frame rate of the video to be encoded corresponding to each playback mode. Specifically, in response to multi-mode coding, different modes may correspond to different mode frame rates. In view of the above, it is required to adjust the video frame rate of the target video. For example, frame drop processing is performed on the target video to decrease the frame rate. Alternatively, frame duplication processing is performed on the target video to increase the frame rate. Thus, the video to be encoded and having each mode frame rate is obtained, and the switching video frame in each video to be encoded is determined. Accordingly, alignment of the switching picture during multi-mode encoding can also be ensured in a variable frame rate scenario.

Specifically, if the mode frame rate corresponding to the playback mode is not equal to the video frame rate of the target video, the switching video frame in the target video may be marked, and frame drop or frame duplication processing may be performed in a video frame range unmarked in the target video. Thus, a processed video frame rate is equal to the mode frame rate, so that the video to be encoded at the mode frame rate is obtained, and a video frame marked in the video to be encoded is taken as the switching video frame. By performing a frame drop in the video frame range unmarked in the target video, a drop of the switching video frame can be avoided, so that an alignment effect of the switching video frame can be ensured.

S240, the target video is encoded based on a respective playback mode with the switching video frame in the video to be encoded as the key frame to obtain the encoded video corresponding to each playback mode.

Specifically, the video to be encoded corresponding to each playback mode may be input to a corresponding encoder. Each encoder encodes the video to be encoded based on the corresponding mode with the switching video frame in the input video to be encoded as the key frame to obtain the encoded video corresponding to each playback mode after alignment of the switching video frame. The video frame rate corresponding to the encoded video is the corresponding mode frame rate. Accordingly, alignment of the switching picture can also be ensured when the mode frame rate changes, and personalized demands are further satisfied.

Illustratively, S240 may include: a current video to be encoded corresponding to a current playback mode is acquired for each playback mode; and encoding is performed with each switching video frame in the current video to be encoded as a first key frame in a group of pictures to obtain an encoded video corresponding to the current playback mode.

Specifically, each playback mode may be taken as the current playback mode. The video is encoded in the above manner to obtain the encoded video corresponding to each playback mode. For example, the video frames in the current video to be encoded may be grouped based on the switching video frame in the current video to be encoded to obtain each frame group corresponding to the current playback mode, and a first video frame in each frame group is the switching video frame. One frame group may be taken as one group of pictures. Alternatively, one frame group may be further divided, and in other words, one frame group corresponds to multiple groups of pictures. The switching video frame is taken as the first video frame in the group of pictures. The switching video frame in each frame group is encoded as a first key frame in one group of pictures to obtain the encoded video corresponding to the current video to be encoded. Thus, alignment of the key frame in the encoded videos corresponding to different playback modes is implemented.

It should be noted that one encoded video may include multiple groups of pictures, and each group of pictures may include one or more key frames. Each switching video frame is the first key frame in the group of pictures, and other key frames in the group of pictures are decided by the encoder autonomously. Thus, alignment of the video picture in response to switching the mode may be ensured only by aligning the key frames corresponding to the switching video frames.

According to the technical solution in the example of the disclosure, the video to be encoded corresponding to each playback mode and the switching video frame in the video to be encoded are obtained by adjusting the frame rate of the target video. The target video is encoded based on a respective playback mode with the switching video frame in the video to be encoded as the key frame to obtain the encoded video corresponding to each playback mode. Thus, alignment of the switching picture during multi-mode encoding can also be ensured in a variable frame rate scenario, and personalized demands can be further satisfied.

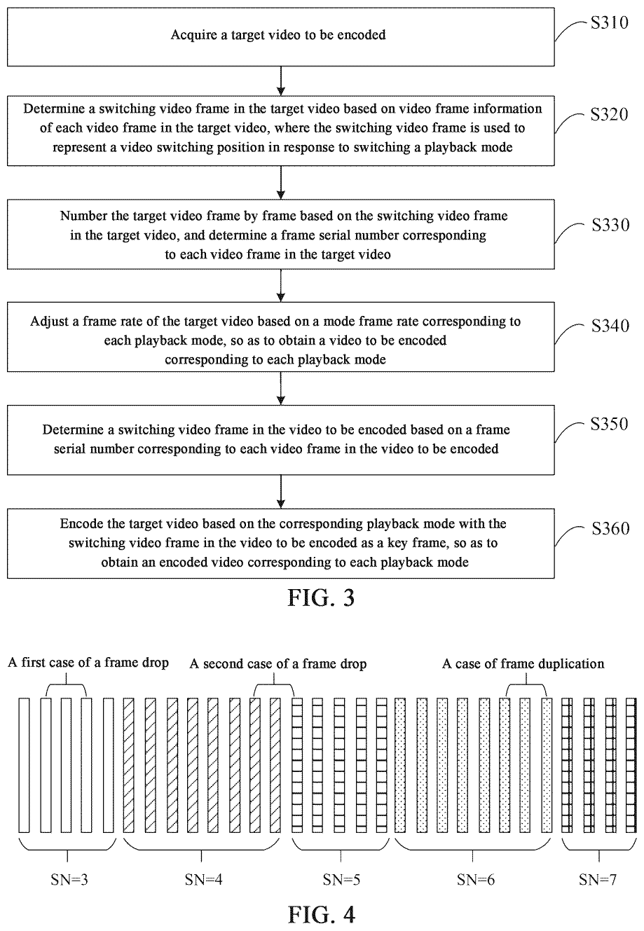

FIG. 3 is a schematic flowchart of yet another method for encoding a video according to an example of the disclosure. On the basis of the example disclosed above, in the example of the disclosure, the step that “a frame rate of the target video is adjusted based on the switching video frame in the target video and a mode frame rate corresponding to each playback mode to obtain a video to be encoded corresponding to each playback mode and a switching video frame in the video to be encoded” is further optimized. The explanations of terms identical or corresponding to those in each example disclosed above will not be repeated herein.

As shown in FIG. 3, the method for encoding a video may specifically include:

S310, a target video to be encoded is acquired.

S320, a switching video frame in the target video is determined based on video frame information of each video frame in the target video, and the switching video frame is used to represent a video switching position in response to switching a playback mode.

S330, the target video is numbered frame by frame based on the switching video frame in the target video, and a frame serial number corresponding to each video frame in the target video is determined.

Specifically, the switching video frame and non-switching video frames in the target video may be encoded as different frame serial numbers for effective differentiation. The non-switching video frames may represent the other video frame except the switching video frame in the target video. For example, each switching video frame in the target video may be encoded as a first frame serial number, and each non-switching video frame may be encoded as a second frame serial number, and the first frame serial number is different from the second frame serial number. The switching video frame and the non-switching video frame in the target video can be more conveniently and rapidly differentiated from each other by numbering each video frame in the target video.

Illustratively, S330 may include: video frames in the target video are grouped with the switching video frame in the target video as a demarcation point to obtain multiple frame groups; and a frame serial number corresponding to each video frame in each frame group is determined, where the video frames in a same frame group correspond to a same frame serial number, and the video frames in different frame groups correspond to different frame serial numbers. The frame group is a set of multiple video frames after division.

Specifically, FIG. 4 shows an example of frame serial numbers corresponding to video frames, and only some video frames in the target video are shown in FIG. 4. With each switching video frame in the target video as the demarcation point, the target video is divided into groups to obtain multiple frame groups, where 5 frame groups are shown in FIG. 4. In the example, division may be performed with the switching video frame as a first video frame in the frame group, and in other words, the first video frame in each frame group obtained is the switching video frame. Alternatively, division may be performed with the switching video frame as a last video frame in the frame group, and in other words, the last video frame in each frame group obtained is the switching video frame. Frame serial numbers corresponding to the video frames in each frame group may be sequentially allocated in an arrangement order of the frame groups. Each video frame in a same frame group corresponds to a same frame serial number, and the frame serial numbers corresponding to different frame groups are increased sequentially in the arrangement order of the frame groups, as shown in FIG. 4. Through such a numbering method, a position of the switching video frame can be located through a frame serial number change position.

S340, a frame rate of the target video is adjusted based on a mode frame rate corresponding to each playback mode to obtain a video to be encoded corresponding to each playback mode.

Specifically, a non-switching video frame range in the target video may be determined by the frame serial number. For example, frame drop or frame duplication processing is performed in a video frame range corresponding to a second frame serial number. Thus, a drop of the switching video frame can be avoided, and an alignment effect of the switching video frame can be ensured.

Illustratively, for the numbering approach in FIG. 4, the frame rate may be adjusted throughout an entire target video range to adapt to an original frame rate adjustment strategy. Moreover, continuity of the switching pictures is ensured within an acceptable switching picture change range. As shown in FIG. 4, three frames are dropped from a group of pictures in a first case of a frame drop. In this case, the boundary between serial number (SN)=3 and SN=4 is not affected, and one key frame corresponding to the switching video frame may be generated at the boundary. Three frames are dropped from a boundary of a group of pictures in a second case of a frame drop. In this case, a new boundary generated between SN=3 and SN=4 is not affected, and one key frame corresponding to the switching video frame may alternatively be generated at the new boundary generated, such as a foremost video frame with SN=5. Three frames are duplicated in a group of pictures in response to frame duplication. In this case, a boundary between SN=6 and SN=7 is not affected, and one key frame corresponding to the switching video frame may be generated at the boundary. The numbering approach in FIG. 4 can be adapted to the original frame rate adjustment strategy. By generating one key frame at the serial number change position, alignment of the picture during multi-mode encoding can be ensured.

S350, the switching video frame in the video to be encoded is determined based on the frame serial number corresponding to each video frame in the video to be encoded.

Specifically, in response to differentiation through the first frame serial number and the second frame serial number, the video frame corresponding to the first frame serial number in the video to be encoded may be directly determined as the switching video frame.

Illustratively, S350 may include: the switching video frame in the video to be encoded is determined based on a frame serial number change position in the video to be encoded. Specifically, for the numbering manner in FIG. 4, if the first video frame in each frame group is the switching video frame, the video frame corresponding to a first frame serial number in each group of frame serial numbers of the video to be encoded may be determined as the switching video frame. If the last video frame in each frame group is the switching video frame, the video frame corresponding to a last frame serial number in each group of frame serial numbers of the video to be encoded may be determined as the switching video frame. By determining the video frame at the frame serial number change position in the video to be encoded as the switching video frame, an alignment effect of the picture can be effectively ensured.

S360, the target video is encoded based on a respective playback mode with the switching video frame in the video to be encoded as the key frame to obtain the encoded video corresponding to each playback mode.

Specifically, the video to be encoded corresponding to each playback mode may be input to a corresponding encoder. Each encoder encodes the video to be encoded based on the corresponding mode with the switching video frame in the input video to be encoded as the key frames to obtain the encoded video corresponding to each playback mode after alignment of the switching video frame. The video frame rate corresponding to the encoded video is the corresponding mode frame rate. Accordingly, alignment of the switching picture can also be ensured when the mode frame rate changes, and personalized demands are further satisfied.

According to the technical solution in the example of the disclosure, the target video is numbered frame by frame based on the switching video frame in the target video, and the frame serial number corresponding to each video frame in the target video is determined. The frame rate of the target video is adjusted based on the mode frame rate corresponding to each playback mode to obtain the video to be encoded corresponding to each playback mode. The switching video frame in the video to be encoded is determined based on the frame serial number corresponding to each video frame in the video to be encoded. Thus, the frame rate can be adjusted more conveniently and rapidly through a frame-by-frame numbering method, and the alignment effect of the switching picture can be ensured.

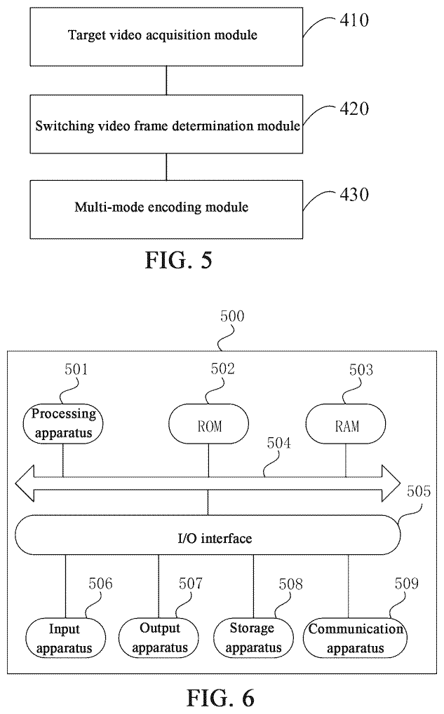

FIG. 5 is a schematic structural diagram of an apparatus for encoding a video according to an example of the disclosure. As shown in FIG. 5, the apparatus specifically includes: a target video acquisition module 410, a switching video frame determination module 420, and a multi-mode encoding module 430.

The target video acquisition module 410 is configured to acquire a target video to be encoded; the switching video frame determination module 420 is configured to determine a switching video frame in the target video based on video frame information of each video frame in the target video, and the switching video frame is used to represent a video switching position in response to switching a playback mode; and the multi-mode encoding module 430 is configured to perform multi-mode encoding on the target video with the switching video frame as a key frame to obtain an encoded video corresponding to each playback mode.

According to the technical solution in the example of the disclosure, the switching video frame in the target video is determined based on the video frame information of each video frame in the target video to be encoded, where the switching video frame is used to represent the video switching position in response to switching the playback mode. Encoding is performed with the switching video frame in the target video as the key frame in each mode. Thus, the switching video frame in the encoded video corresponding to each playback mode is aligned, so that alignment of the switching video picture can be ensured in response to switching the playback mode, and continuity of video switching can be improved.

On the basis of the above technical solution, the video frame information may include at least one of texture information, motion information, shot switching information, shot scene information, a playback timestamp.

On the basis of each technical solution described above, the switching video frame determination module 420 is specifically configured to:

input the video frame information of each video frame in the target video into a target network model obtained through pre-training, and predict the switching video frame; and determine the switching video frame in the target video based on a prediction result output by the target network model.

On the basis of each technical solution described above, the multi-mode encoding module 430 includes:
a frame rate adjustment sub-module configured to adjust a frame rate of the target video based on the switching video frame in the target video and a mode frame rate corresponding to each playback mode to obtain a video to be encoded corresponding to each playback mode and a switching video frame in the video to be encoded; and
a mode encoding sub-module configured to encode the target video based on a playback mode with the switching video frame in the video to be encoded as the key frame to obtain the encoded video corresponding to each playback mode.

On the basis of each technical solution described above, the frame rate adjustment sub-module includes:
a frame-by-frame numbering unit configured to number the target video frame by frame based on the switching video frame in the target video, and determine a frame serial number corresponding to each video frame in the target video;
a frame rate adjustment unit configured to adjust the frame rate of the target video based on the mode frame rate corresponding to each playback mode, so as to obtain the video to be encoded corresponding to each playback mode; and
a video frame determination unit configured to determine the switching video frame in the video to be encoded based on the frame serial number corresponding to each video frame in the video to be encoded.

On the basis of each technical solution described above, the frame-by-frame numbering unit is specifically configured to:
group video frames in the target video with the switching video frame in the target video as a demarcation point, so as to obtain multiple frame groups; and determine a frame serial number corresponding to each video frame in each frame group, where the video frames in a same frame group correspond to a same frame serial number, and the video frames in different frame groups correspond to different frame serial numbers.

On the basis of each technical solution described above, the video frame determination unit is specifically configured to:
determine the switching video frame in the video to be encoded based on a frame serial number change position in the video to be encoded.

On the basis of each technical solution described above, the mode encoding sub-module is specifically configured to:
acquire a current video to be encoded corresponding to a current playback mode for each playback mode; and perform encoding with each switching video frame in the current video to be encoded as a first key frame in a group of pictures, so as to obtain an encoded video corresponding to the current playback mode.

On the basis of each technical solution described above, the apparatus further includes:
a second playback mode determination module configured to play back a first encoded video corresponding to a first playback mode after the encoded video corresponding to each playback mode is acquired, and determine a second playback mode to be switched to in response to a playback mode switching instruction; and
a playback mode switching module configured to switch to the second playback mode in response to reaching a switching position corresponding to a switching video frame in the first encoded video, and synchronously play back a second encoded video corresponding to the second playback mode.

The apparatus for encoding a video according to the embodiments of the disclosure can execute the method for encoding a video according to any example of the disclosure, has the corresponding function modules for executing the method for encoding a video, and exerts the beneficial effects.

It should be noted that all the units and modules included in the above apparatus are divided merely by function logic, but are not limited to the above division, as long as corresponding functions can be implemented. Also, the specific name of each function unit is merely for ease of differentiation from one another, and is not used to limit the scope of protection in the embodiments of the disclosure.

FIG. 6 is a schematic structural diagram of an electronic device according to an example of the disclosure. With reference to FIG. 6 below, a schematic structural diagram of an electronic device 500 (for example, a terminal device or a server in FIG. 6) suitable for implementing the example of the disclosure is shown. The terminal device in the example of the disclosure can include, but is not limited to, mobile terminals such as a mobile phone, a notebook computer, a digital broadcast receiver, a personal digital assistant (PDA), a pad, a portable multimedia player (PMP), and an in-vehicle terminal (for example, an in-vehicle navigation terminal), and fixed terminals such as a digital television (TV) and a desktop computer. The electronic device shown in FIG. 6 is merely illustrative, and should not limit the functions and use scope in the example of the disclosure in any way.

As shown in FIG. 6, the electronic device 500 can include a processing apparatus 501 (for example, a central processing unit or a graphic processor) that can execute various suitable actions and processing according to a program stored in a read-only memory (ROM) 502 or loaded into a random access memory (RAM) 503 from a storage apparatus 508. The RAM 503 can also store various programs and data required for an operation of the electronic device 500. The processing apparatus 501, the ROM 502, and the RAM 503 are connected to one another through a bus 504. An input/output (I/O) interface 505 is also connected to the bus 504.

Typically, the I/O interface 505 can be connected to the following apparatuses: an input apparatus 506 such as a touch screen, a touch pad, a keyboard, a mouse, a camera, a microphone, an accelerometer, and a gyroscope; an output apparatus 507 such as a liquid crystal display (LCD), a speaker, and a vibrator; a storage apparatus 508 such as a magnetic tape and a hard disk; and a communication apparatus 509. The communication apparatus 509 can allow wireless or wired communication between the electronic device 500 and other devices for data exchange. Although FIG. 6 shows the electronic device 500 having various apparatuses, it should be understood that not all the apparatuses shown are required to be implemented or configured. More or fewer apparatuses can be implemented or configured alternatively.

Particularly, the processes described above with reference to the flowcharts can be implemented as computer software programs according to the example of the disclosure. For example, a computer program product is included in the embodiments of the disclosure. The computer program product includes a computer program carried on a non-transitory computer-readable medium and encompassing a program code configured to execute the method shown in the flowchart. In such an example, the computer program can be downloaded and installed over a network through the communication apparatus 509, installed via the storage apparatus 508, or installed via the ROM 502. The computer program executes the above functions defined in the method in the example of the disclosure when executed by the processing apparatus 501.

The name of a message or information interacting between a plurality of apparatuses in the embodiments of the disclosure is merely descriptive, and is not intended to limit the scope of the message or information.

The electronic device according to the embodiments of the disclosure and the method for encoding a video according to the above example belong to the same inventive concept, so that reference can be made to the above example for the technical details not described in detail in the example, and the example has the same beneficial effect as the above example.

A computer storage medium is provided in the embodiments of the disclosure. The computer storage medium stores a computer program, where the computer program implements the method for encoding a video according to the above example when executed by a processor.

It should be noted that the above computer-readable medium of the disclosure can be a computer-readable signal medium, a computer-readable storage medium, or any combinations of the above. The computer-readable storage medium can include, but is not limited to, an electronic, magnetic, optical, electromagnetic, infrared, or semiconductor system, apparatus, or device, or any combinations of the above. More specific examples of the computer-readable storage medium can include, but are not limited to, a portable computer magnetic disk, a hard disk, a random access memory (RAM), a read-only memory (ROM), an erasable programmable read-only memory (EPROM) or a flash memory, an optical fiber, a portable compact disk read-only memory (CD-ROM), an optical storage device, and a magnetic storage device that are each electrically connected through one or more wires, or any suitable combinations of the above. In the disclosure, the computer-readable storage medium can be any tangible medium that encompasses or stores a program. The program can be used by or in combination with an instruction execution system, apparatus, or device. In the disclosure, however, the computer-readable signal medium can include a data signal propagated in a baseband or as part of a carrier wave, having a computer-readable program code carried thereon. Such a propagated data signal can take various forms including, but not limited to, an electromagnetic signal, an optical signal, or any suitable combinations of the above. The computer-readable signal medium can alternatively be any computer-readable medium except for the computer-readable storage medium. The computer-readable signal medium can transmit, propagate, or transfer a program to be used by or in combination with the instruction execution system, apparatus, or device. The program codes encompassed in the computer-readable medium can be transmitted via any suitable medium, including, but not limited to, a wire, an optical cable, a radio frequency (RF), etc., or any suitable combinations of the above.

In some embodiments, clients and servers can communicate with each other via any currently known network protocol (such as a hypertext transfer protocol (HTTP)) or any network protocol to be developed in the future, and can be interconnected to digital data communication (for example, a communication network) in any form or medium. Examples of the communication network include a local area network (LAN), a wide area network (WAN), the Internet, a peer-to-peer network (for example, an ad hoc peer-to-peer network), any currently known network, or any network to be developed in the future.

The above computer-readable medium can be encompassed in the above electronic device, or exist alone without being assembled into the electronic device.

The above computer-readable medium carries one or more programs. When executed by the electronic device, the above one or more programs cause the electronic device to:
acquire a target video to be encoded; determine a switching video frame in the target video based on video frame information of each video frame in the target video, where the switching video frame is used to represent a video switching position in response to switching a playback mode; and perform multi-mode encoding on the target video with the switching video frame as a key frame, so as to obtain an encoded video corresponding to each playback mode.

The computer program codes configured to execute operations of the disclosure can be written in one or more programming languages or their combinations. The above programming languages include, but are not limited to, object-oriented programming languages, such as Java, Smalltalk, and C++, and conventional procedural programming languages, such as “C” language. The program code can be executed on a user's computer in whole or in part, executed as an independent software package, executed on a user's computer and a remote computer both in part, or executed on a remote computer or a server in whole. In a case involving the remote computer, the remote computer can be connected to the user's computer through any kind of network, including the local area network (LAN) or the wide area network (WAN), or can be connected to an external computer (for example, through the Internet on the basis of an Internet service provider).

The flowcharts and block diagrams in the accompanying drawings illustrate possibly-implementable system architectures, functions, and operations of the systems, methods, and computer program products according to various embodiments of the disclosure. In this regard, each block in the flowcharts or the block diagrams can represent a module, a program segment, or a code segment, which encompasses one or more executable instructions configured to implement specified logic functions. It should also be noted that in some alternative implementations, the functions noted in the blocks can also occur in an order other than those noted in the accompanying drawings. For example, two blocks represented in succession can in fact be executed substantially in parallel or in a reverse order sometimes, depending on the functions involved. It should also be noted that each block in the block diagrams and/or the flowcharts and combinations of blocks in the block diagrams and/or the flowcharts can be implemented through specific hardware-based systems that execute the specified functions or operations, or combinations of specific hardware and computer instructions.

The units involved in the embodiments of the disclosure can be implemented through software or hardware. The name of the unit is not intended to define the unit itself under a certain circumstance. For example, a first acquisition unit can also be described as “a unit that acquires at least two Internet protocol addresses”.

At least part of the above functions can be executed by one or more hardware logic components herein. For example, non-restrictively, illustrative types of usable hardware logic components include: a field programmable gate array (FPGA), an application specific integrated circuit (ASIC), an application specific standard product (ASSP), a system on chip (SOC), a complex programmable logic device (CPLD), etc.

In the context of the disclosure, a machine-readable medium can be a tangible medium that can encompass or store a program to be used by or in combination with the instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combinations of the above. More specific examples of the machine-readable storage media include a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, and a magnetic storage device that are each electrically connected through one or more wires, or any suitable combinations of the above.

According to one or more embodiments of the disclosure, a method for encoding a video is provided in [Example 1]. The method includes:
a target video to be encoded is acquired;
a switching video frame in the target video is determined based on video frame information of each video frame in the target video, where the switching video frame is used to represent a video switching position in response to switching a playback mode; and
multi-mode encoding is performed on the target video with the switching video frame as a key frame, so as to obtain an encoded video corresponding to each playback mode.

According to one or more embodiments of the disclosure, a method for encoding a video is provided in [Example 2].

Optionally, the video frame information includes at least one of texture information, motion information, shot switching information, shot scene information, a playback timestamp.

According to one or more embodiments of the disclosure, a method for encoding a video is provided in [Example 3].

Optionally, the step that a switching video frame in the target video is determined based on video frame information of each video frame in the target video includes:
the video frame information of each video frame in the target video is input into a target network model obtained through pre-training, and the switching video frame is predicted; and
the switching video frame in the target video is determined based on a prediction result output by the target network model.

According to one or more embodiments of the disclosure, a method for encoding a video is provided in [Example 4].

Optionally, the step that multi-mode encoding is performed on the target video with the switching video frame as a key frame, so as to obtain an encoded video corresponding to each playback mode includes:
a frame rate of the target video is adjusted based on the switching video frame in the target video and a mode frame rate corresponding to each playback mode, so as to obtain a video to be encoded corresponding to each playback mode and a switching video frame in the video to be encoded; and
the target video is encoded based on a respective playback mode with the switching video frame in the video to be encoded as the key frame, so as to obtain the encoded video corresponding to each playback mode.

According to one or more embodiments of the disclosure, a method for encoding a video is provided in [Example 5].

Optionally, the step that a frame rate of the target video is adjusted based on the switching video frame in the target video and a mode frame rate corresponding to each playback mode, so as to obtain a video to be encoded corresponding to each playback mode and a switching video frame in the video to be encoded includes:
the target video is numbered frame by frame based on the switching video frame in the target video, and a frame serial number corresponding to each video frame in the target video is determined;
the frame rate of the target video is adjusted based on the mode frame rate corresponding to each playback mode to obtain the video to be encoded corresponding to each playback mode; and
the switching video frame in the video to be encoded is determined based on the frame serial number corresponding to each video frame in the video to be encoded.

According to one or more embodiments of the disclosure, a method for encoding a video is provided in [Example 6].

Optionally, the step that the target video is numbered frame by frame based on the switching video frame in the target video, and a frame serial number corresponding to each video frame in the target video is determined includes:
video frames in the target video are grouped with the switching video frame in the target video as a demarcation point, so as to obtain multiple frame groups; and
a frame serial number corresponding to each video frame in each frame group is determined, where the video frames in a same frame group correspond to a same frame serial number, and the video frames in different frame groups correspond to different frame serial numbers.

According to one or more embodiments of the disclosure, a method for encoding a video is provided in [Example 7].

Optionally, the step that the switching video frame in the video to be encoded is determined based on the frame serial number corresponding to each video frame in the video to be encoded includes:
the switching video frame in the video to be encoded is determined based on a frame serial number change position in the video to be encoded.

According to one or more embodiments of the disclosure, a method for encoding a video is provided in [Example 8].

Optionally, the step that the target video is encoded based on a respective playback mode with the switching video frame in the video to be encoded as the key frame, so as to obtain the encoded video corresponding to each playback mode includes:
a current video to be encoded corresponding to a current playback mode is acquired for each playback mode; and
encoding is performed with each switching video frame in the current video to be encoded as a first key frame in a group of pictures, so as to obtain an encoded video corresponding to the current playback mode.

According to one or more embodiments of the disclosure, a method for encoding a video is provided in [Example 9].

Optionally, after the encoded video corresponding to each playback mode is acquired, the method further includes:
a first encoded video corresponding to a first playback mode is played back, and a second playback mode to be switched to is determined in response to a playback mode switching instruction; and
switch to the second playback mode is performed in response to reaching a switching position corresponding to a switching video frame in the first encoded video, and a second encoded video corresponding to the second playback mode is synchronously played back.

According to one or more embodiments of the disclosure, an apparatus for encoding a video is provided in [Example 10]. The apparatus includes:
a target video acquisition module configured to acquire a target video to be encoded;
a switching video frame determination module configured to determine a switching video frame in the target video based on video frame information of each video frame in the target video, where the switching video frame is used to represent a video switching position in response to switching a playback mode; and
a multi-mode encoding module configured to perform multi-mode encoding on the target video with the switching video frame as a key frame, so as to obtain an encoded video corresponding to each playback mode.

What are described above are merely preferred embodiments of the disclosure and descriptions of the technical principles applied. It should be understood by those skilled in the art that the scope of disclosure involved in the disclosure is not limited to the technical solutions formed by specific combinations of the above technical features, and should also cover other technical solutions formed by random combinations of the above technical features or their equivalents without departing from the concept disclosed above. For example, other technical solutions include those formed through mutual replacement between the above features and the technical features having similar functions disclosed in the disclosure (but not limited thereto).

In addition, all the operations are depicted in a specific order. However, it should not be understood that these operations are required to be executed in the specific order shown or in a successive order. Under certain circumstances, multitasking and parallel processing may be advantageous. Similarly, several specific implementation details are encompassed in the above discussion, but should not be interpreted as limiting the scope of the disclosure. Some features that are described in the context of the separate embodiments can also be implemented jointly in the single example. Likewise, various features that are described in the context of the single example can also be implemented in a plurality of embodiments separately or in any suitable sub-combination manner.

Although the subject has been described in a language specific to structural features and/or logic actions of the method, it should be understood that the subject defined in the appended claims is not necessarily limited to the above specific features or actions. Rather, the above specific features and actions are merely illustrative forms for implementing the claims.

1. A method for encoding a video, comprising:
acquiring a target video to be encoded;
determining a switching video frame in the target video based on video frame information of each video frame in the target video, the switching video frame being used to represent a video switching position in response to switching a playback mode; and
performing multi-mode encoding on the target video with the switching video frame as a key frame to obtain an encoded video corresponding to each playback mode.

2. The method for encoding a video according to claim 1, wherein the video frame information comprises at least one of texture information, motion information, shot switching information, shot scene information, and a playback timestamp.

3. The method for encoding a video according to claim 1, wherein determining the switching video frame in the target video based on video frame information of each video frame in the target video comprises:
inputting the video frame information of each video frame in the target video into a target network model obtained by pre-training to predict the switching video frame; and
determining the switching video frame in the target video based on a prediction result output by the target network model.

4. The method for encoding a video according to claim 1, wherein performing multi-mode encoding on the target video with the switching video frame as the key frame, to obtain the encoded video corresponding to each playback mode comprises:
adjusting a frame rate of the target video based on the switching video frame in the target video and a mode frame rate corresponding to each playback mode, to obtain a video to be encoded corresponding to each playback mode and a switching video frame in the video to be encoded; and
encoding the target video based on a respective playback mode with the switching video frame in the video to be encoded as the key frame to obtain the encoded video corresponding to each playback mode.

5. The method for encoding a video according to claim 4, wherein adjusting the frame rate of the target video based on the switching video frame in the target video and the mode frame rate corresponding to each playback mode to obtain the video to be encoded corresponding to each playback mode and the switching video frame in the video to be encoded comprises:
numbering the target video frame by frame based on the switching video frame in the target video to determine a frame serial number corresponding to each video frame in the target video;
adjusting the frame rate of the target video based on the mode frame rate corresponding to each playback mode to obtain the video to be encoded corresponding to each playback mode; and
determining the switching video frame in the video to be encoded based on the frame serial number corresponding to each video frame in the video to be encoded.

6. The method for encoding a video according to claim 5, wherein numbering the target video frame by frame based on the switching video frame in the target video to determine the frame serial number corresponding to each video frame in the target video comprises:
grouping video frames in the target video with the switching video frame in the target video as a demarcation point to obtain multiple frame groups; and
determining a frame serial number corresponding to each video frame in each frame group, wherein the video frames in a same frame group correspond to a same frame serial number, and the video frames in different frame groups correspond to different frame serial numbers.

7. The method for encoding a video according to claim 6, wherein determining the switching video frame in the video to be encoded based on the frame serial number corresponding to each video frame in the video to be encoded comprises:
determining the switching video frame in the video to be encoded based on a frame serial number change position in the video to be encoded.

8. The method for encoding a video according to claim 4, wherein encoding the target video based on the corresponding playback mode with the switching video frame in the video to be encoded as the key frame to obtain the encoded video corresponding to each playback mode comprises:
acquiring, for each playback mode, a current video to be encoded corresponding to a current playback mode; and
performing encoding with each switching video frame in the current video to be encoded as a first key frame in a group of pictures to obtain an encoded video corresponding to the current playback mode.

9. The method for encoding a video according to claim 1, wherein after acquiring the encoded video corresponding to each playback mode, the method further comprises:
playing a first encoded video corresponding to a first playback mode, and determining a second playback mode to be switched to in response to a playback mode switching instruction; and
switching to the second playback mode in response to reaching a switching position corresponding to a switching video frame in the first encoded video, and synchronously playing a second encoded video corresponding to the second playback mode.

10. (canceled)

11. An electronic device, comprising:
one or more processors; and
a storage apparatus configured to store instructions;
when executed by the one or more processors, the instructions cause the one or more processors to:
acquire a target video to be encoded;
determine a switching video frame in the target video based on video frame information of each video frame in the target video, the switching video frame being used to represent a video switching position in response to switching a playback mode; and
perform multi-mode encoding on the target video with the switching video frame as a key frame to obtain an encoded video corresponding to each playback mode.

12. A non-transitory storage medium, comprising computer-executable instructions, wherein the computer-executable instructions cause a computer processor to:
acquire a target video to be encoded;
determine a switching video frame in the target video based on video frame information of each video frame in the target video, the switching video frame being used to represent a video switching position in response to switching a playback mode; and
perform multi-mode encoding on the target video with the switching video frame as a key frame to obtain an encoded video corresponding to each playback mode.

13. The device according to claim 11, wherein the video frame information comprises at least one of texture information, motion information, shot switching information, shot scene information, and a playback timestamp.

14. The device according to claim 11, wherein instructions causing the processor to determine the switching video frame in the target video based on video frame information of each video frame in the target video comprise instructions causing the processor to:
input the video frame information of each video frame in the target video into a target network model obtained by pre-training to predict the switching video frame; and
determine the switching video frame in the target video based on a prediction result output by the target network model.

15. The device according to claim 11, wherein instructions causing the processor to perform multi-mode encoding on the target video with the switching video frame as the key frame, to obtain the encoded video corresponding to each playback mode comprise instructions causing the processor to:
adjust a frame rate of the target video based on the switching video frame in the target video and a mode frame rate corresponding to each playback mode, to obtain a video to be encoded corresponding to each playback mode and a switching video frame in the video to be encoded; and
encode the target video based on a respective playback mode with the switching video frame in the video to be encoded as the key frame to obtain the encoded video corresponding to each playback mode.

16. The device according to claim 15, wherein instructions causing the processor to adjust the frame rate of the target video based on the switching video frame in the target video and the mode frame rate corresponding to each playback mode to obtain the video to be encoded corresponding to each playback mode and the switching video frame in the video to be encoded comprise instructions causing the processor to:
number the target video frame by frame based on the switching video frame in the target video to determine a frame serial number corresponding to each video frame in the target video;
adjust the frame rate of the target video based on the mode frame rate corresponding to each playback mode to obtain the video to be encoded corresponding to each playback mode; and
determine the switching video frame in the video to be encoded based on the frame serial number corresponding to each video frame in the video to be encoded.

17. The device according to claim 16, wherein instructions causing the processor to number the target video frame by frame based on the switching video frame in the target video to determine the frame serial number corresponding to each video frame in the target video comprise instructions causing the processor to:
group video frames in the target video with the switching video frame in the target video as a demarcation point to obtain multiple frame groups; and
determine a frame serial number corresponding to each video frame in each frame group, wherein the video frames in a same frame group correspond to a same frame serial number, and the video frames in different frame groups correspond to different frame serial numbers.

18. The device according to claim 17, wherein instructions causing the processor to determine the switching video frame in the video to be encoded based on the frame serial number corresponding to each video frame in the video to be encoded comprise instructions causing the processor to:
determine the switching video frame in the video to be encoded based on a frame serial number change position in the video to be encoded.

19. The device according to claim 15, wherein instructions causing the processor to encode the target video based on the corresponding playback mode with the switching video frame in the video to be encoded as the key frame to obtain the encoded video corresponding to each playback mode comprise instructions causing the processor to:
acquire, for each playback mode, a current video to be encoded corresponding to a current playback mode; and
perform encoding with each switching video frame in the current video to be encoded as a first key frame in a group of pictures to obtain an encoded video corresponding to the current playback mode.

20. The device according to claim 11, wherein after instructions causing the processor to acquire the encoded video corresponding to each playback mode, instructions causing the processor further to:
play a first encoded video corresponding to a first playback mode, and determining a second playback mode to be switched to in response to a playback mode switching instruction; and
switch to the second playback mode in response to reaching a switching position corresponding to a switching video frame in the first encoded video, and synchronously playing a second encoded video corresponding to the second playback mode.

21. The medium according to claim 12, wherein the video frame information comprises at least one of texture information, motion information, shot switching information, shot scene information, and a playback timestamp.
